(19) United States
(12) Patent Application Publication
(10) Pub. No.: US 2004/0040821 A1
(43) Pub. Date: Mar. 4, 2004

(54) Drop safe having a gas spring control system

(76) Inventor: Donald V. Eason, Indianapolis, IN (US)

Correspondence Address: CHRISTIE, PARKER & HALE, LLP, P.O. BOX 7068, PASADENA, CA, 91109-7068, US

(21) Appl. No.: 10/264,457

(22) Filed: Oct. 4, 2002

Related U.S. Application Data
(60) Provisional application No. 60/408,490, filed on Sep. 4, 2002.

(51) Int. Cl. E04H 9/00; G07D 7/00

(52) U.S. Cl. 194/302; 109/2

(57) ABSTRACT

A drop safe is provided, having a pivoting component and a cam attached to an interior surface of the drop safe, wherein the cam has a cam surface. A gas spring moves along the cam surface by means of a cam bearing, which is at one end of the gas spring, such that the cam bearing moves along the cam surface. A link is attached to the gas spring and to the pivoting component, such that as the cam bearing moves along the cam surface, the link applies a force to the pivoting component.

### CROSS REFERENCE TO RELATED APPLICATION(S)

This application claims priority under 35 U.S.C. §119(e) to U.S. Provisional Application Serial No. 60/408,409, filed on Sep. 4, 2002.

### FIELD OF THE INVENTION

The present invention relates generally to a drop safe and more particularly to a drop safe that includes a gas spring having a cam bearing that moves along a cam surface or cam profile for a controlled opening and closing of a drop safe door, chassis or other pivotal component.

### BACKGROUND

A drop safe is a device for receiving and temporarily storing currency or other valuables. Drop safes are typically used in stores such as groceries stores, convenient stores or gas stations. In these stores, it is common to prevent or discourage theft by frequently transferring currency from relatively unsecure devices, such as cash registers or point-of-sale terminals, to relatively secure devices, such as drop safes.

Since drop safes are secure enclosures designed to be “theft-proof”, drop safe doors are often relatively heavy. As a result, when an operator rotates the door towards a closed position or towards an opened position, the weight of the door causes the door to have a tendency to, respectively, “slam” itself shut when the door is almost closed or to swing open very quickly when the door is opened. Thus, producing an undesirable risk of an injury to the operator. For example, the weight of the door may cause the door to close so quickly as to not provide the operator with enough time to remove the operator's hand or fingers from between the door and the door jam during the closing of the door. The “self-closing” nature of the door may similarly cause an injury to the operator's hand or fingers. In addition, the weight the door is cumbersome for some operators to manipulate.

One drop safe of the prior art includes a gas spring attached to a lever that is, in turn, attached to a drop safe door. The gas spring counteracts the weight of the door during opening and closing of the door. See, for example, U.S. Pat. No. 5,695,038.

### SUMMARY

In one embodiment, the present invention includes a drop safe, having a pivoting component and a cam attached to an interior surface of the drop safe, wherein the cam has a cam surface. A gas spring moves along the cam surface by means of a cam bearing, which is at one end of the gas spring, such that the cam bearing moves along the cam surface. A link is attached to the gas spring and to the pivoting component, such that as the cam bearing moves along the cam surface, the link applies a force to the pivoting component.

### BRIEF DESCRIPTION OF THE DRAWINGS

These and other features and advantages of the present invention will be better understood by reference to the following detailed description when considered in conjunction with the accompanying drawings wherein:

FIG. 1 is a side cross-sectional view of a drop safe according to the present invention, wherein a drop safe door is in a closed position;

FIG. 2 is a side cross-sectional view of the drop safe of FIG. 1, wherein a cam bearing is held in a neutral point detent, thus holding the drop safe door in a partially opened position;

FIG. 3 is a side cross-sectional view of the drop safe of FIG. 1, wherein the cam bearing is held in a fully open detent, thus holding the drop safe door in a fully opened position;

FIG. 4 is an enlarged side cross-sectional view of the neutral point detent taken from detail 4 of FIG. 1;

FIG. 5 is an enlarged side cross-sectional view of the fully open detent taken from detail 5 of FIG. 1;

FIG. 6 is a partial side cross-sectional view of the drop safe of FIG. 1, wherein a initial force bracket has been removed to expose a recessed area in a distal end of a cam slot;

FIG. 7 is a perspective cut away view of an initial force bracket of the drop safe of FIG. 1.

FIG. 8 is a perspective cut away view of an embodiment of the invention wherein the gas spring is attached to a chassis, the chassis being shown in a closed position;

FIG. 9 is a perspective cut away view of the chassis of FIG. 8, wherein the chassis is shown in an opened position; and

FIG. 10 is a perspective cut away view of the chassis of FIG. 8.

### DETAILED DESCRIPTION OF EMBODIMENTS OF THE INVENTION

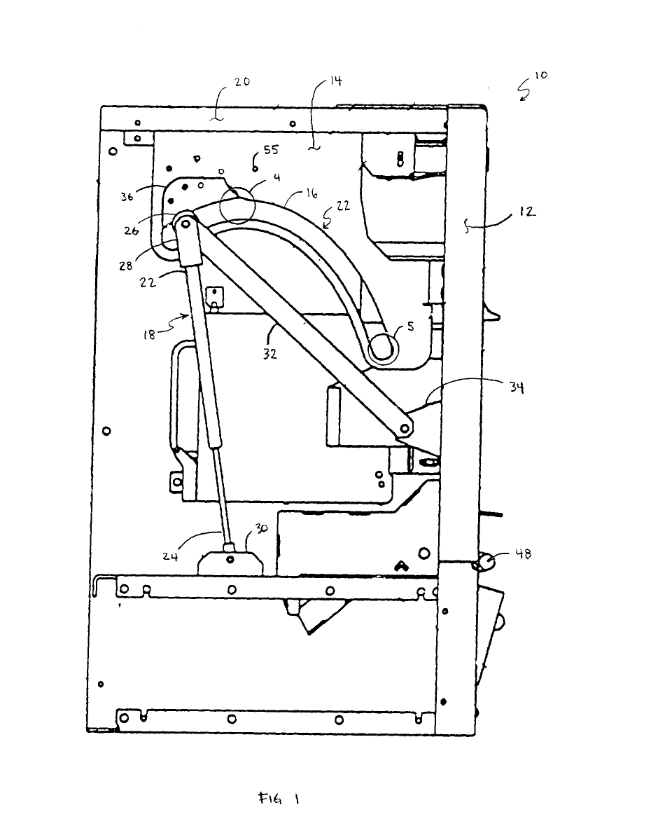

As shown in FIGS. 1-7, an embodiment of the present invention is directed to a drop safe, wherein the drop safe includes a gas spring having a cam bearing that moves along a cam surface (also referred to as a cam profile) for a controlled opening and closing of a drop safe door, and wherein the cam surface has a neutral point detent for holding the drop safe door in a partially opened position and a fully open detent for holding the drop safe door in a fully opened position.

FIG. 1 shows a drop safe 10 according to the present invention, wherein a drop safe door 12 is shown in a closed position. In the depicted embodiment, a cam 14 is attached to an interior surface of the drop safe 10, such as by screw fastening, riveting or welding, among other attachment means. For example, in one embodiment, the cam 14 is a plate that is screw fastened to a mounting bracket 20 on the interior surface of the drop safe 10. The cam 14 may comprise any one of a variety of rigid materials, such as a metal material, for example steel sheet metal, among others. The cam 14 comprises a cam surface or cam profile 16 for engagement with a gas spring 18. For example, in one embodiment, the cam 14 has a slot 22 that defines the cam surface 16.

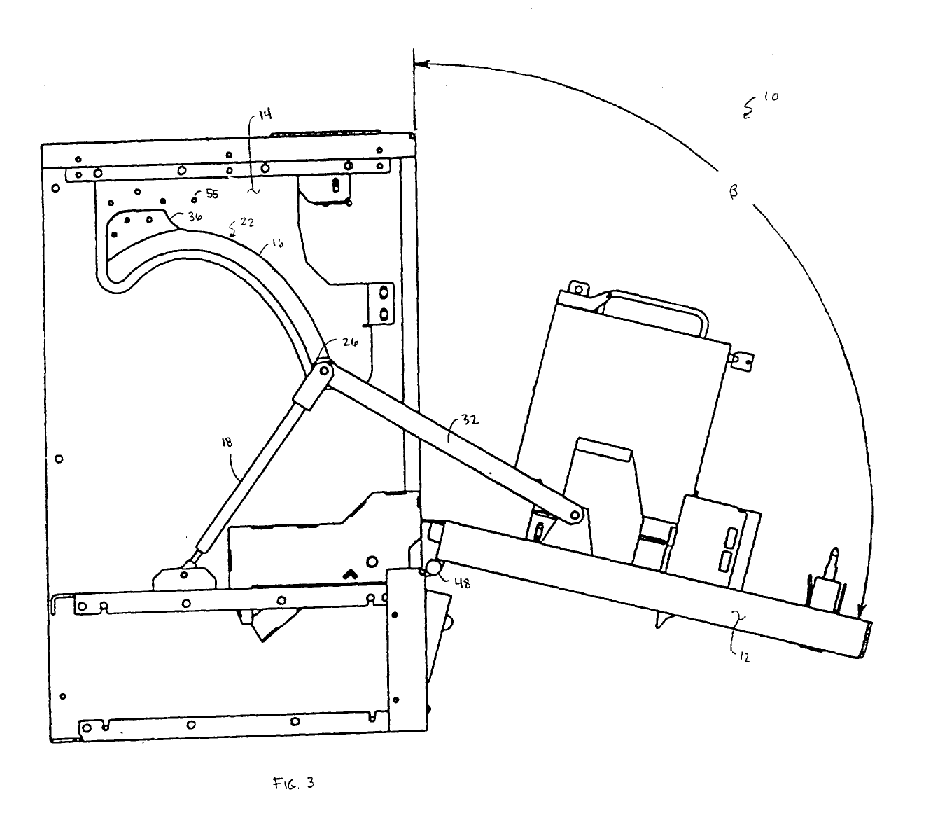

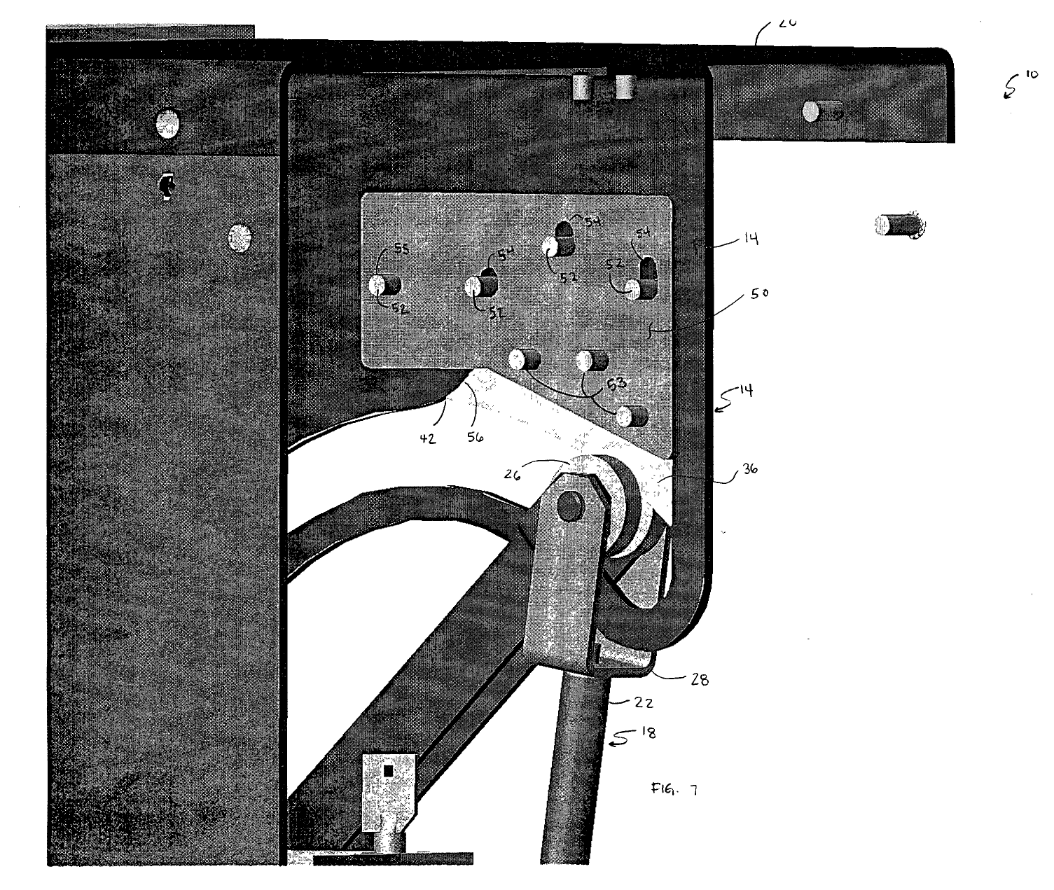

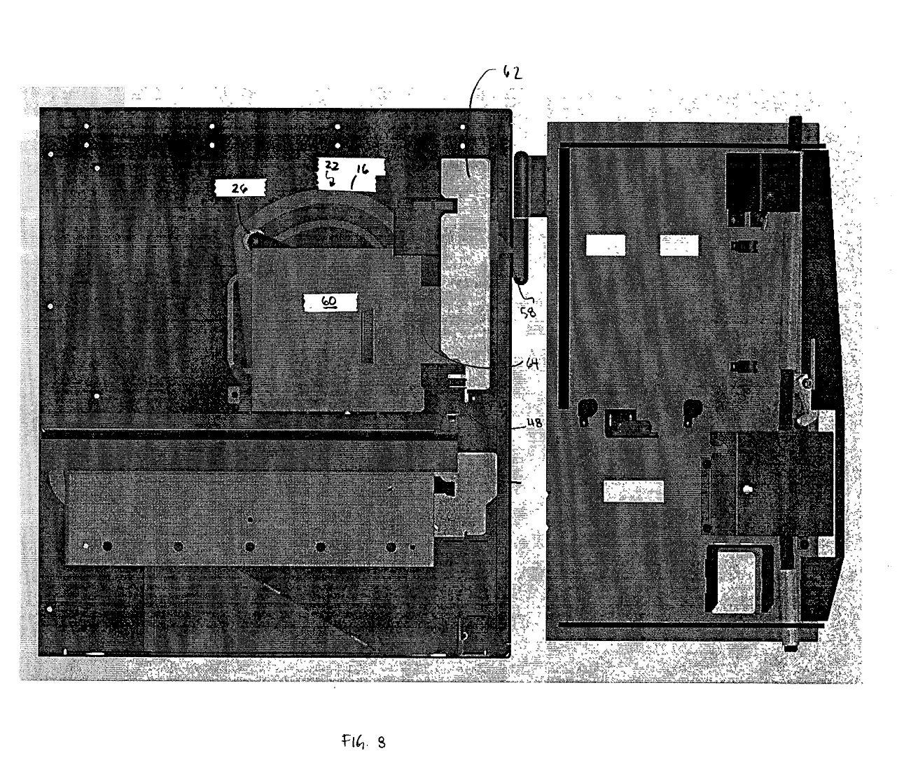

As depicted in FIG. 1, the gas spring 18 has a proximal end 22 and a distal end 24 (for the purposes of this application proximal and distal will be defined by reference to the elements as they appear to an operator looking inside the drop safe 10 when the drop safe 10 is in an opened door position, as in the depiction of FIG. 3). A suitable gas spring 18 for use in the drop safe 10 of the present invention is commercially available from Guden-Hardware for Industry, of Ronkonkoma, N.Y., for example a 120 pound gas spring. In the depicted embodiment, the distal end 24 of the gas spring 18 is attached to the interior surface of the drop safe 10 through a pivot bracket 30. The pivot bracket 30 allows for a pivotable movement of the gas spring 18. A cam bearing 26 is attached to the proximal end 22 of the gas spring 18 for slidable or rotational movement along the cam surface 16. For example, in one embodiment (as best shown in FIG. 7) the proximal end 22 of the gas spring 18 is attached to one end of a yoke bracket 28, and the cam bearing 26 is attached to an opposite end of the yoke bracket 28. The cam bearing 26 may be attached to the yoke bracket 28 by a pin to allow for rotational movement of the cam bearing 26, such that the cam bearing 26 may slidably or rotatably move about the cam surface 16. The cam bearing 26 may comprise any one of a variety of rigid materials, such as a metal material, for example steel, among others.

The gas spring 18 may be connected to the drop safe door 12 by a link 32. For example, in the depicted embodiment, one end of the link 32 is pivotably connected to the yoke bracket 28 and an opposite end of the bracket is pivotably connected to a mounting bracket 34 that is attached to the drop safe door 12.

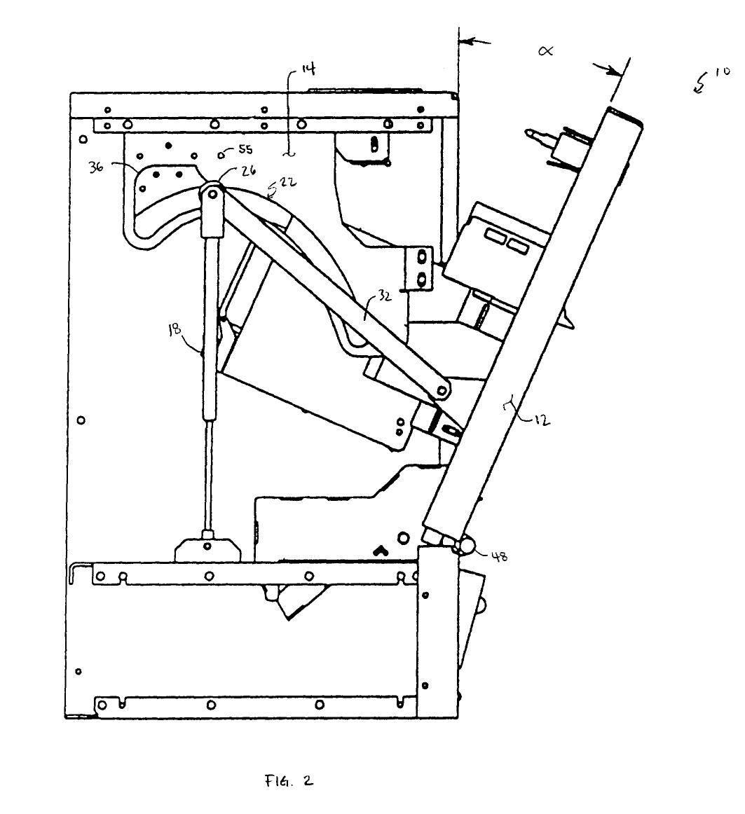

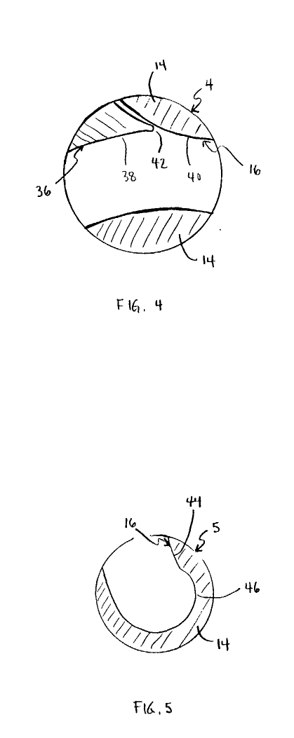

In one embodiment, an initial force bracket 36 is attached to the cam 14, such that the cam bearing 26 moves along the initial force bracket 36 and the cam surface 16. In this embodiment, a proximal end 38 of the initial force bracket 36 and a distal end 40 of the cam surface 16 combine to form a neutral point detent 42 (as best shown in detail 4 of FIG. 4). The neutral point detent 42 temporarily hinders the movement of the gas spring 18 to hold the drop safe door 12 in a partially opened position (as shown in FIG. 2). In the depicted embodiment, the neutral point detent 42 is a v-shaped gap between the proximal end 36 of the initial force bracket 36 and the distal end 40 of the cam surface 16. However, in other embodiments, the neutral point detent 42 may comprise other shapes, such as semi-rectangular, semi-circular or semi-ovular, among others. In addition, in other embodiments, the neutral point detent 42 may be formed as a groove in either the initial force bracket 36 or the cam surface 16. Also, in alternative embodiments, the neutral point detent 42 may be formed as a protrusion from the initial force bracket 36 or the cam surface 16, rather than an indention in the initial force bracket 36 or the cam surface 16 or a gap between the initial force bracket 36 and the cam surface 16.

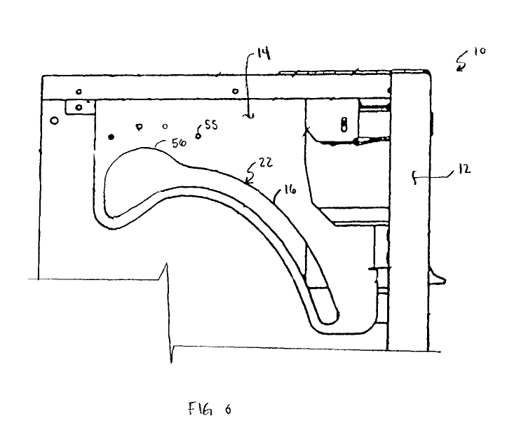

A proximal end 44 of the cam surface 16 comprises a fully open detent 46 (as best shown in detail 5 of FIG. 5). In the depicted embodiment, the fully open detent 46 is a recessed groove in the proximal end 44 of the cam surface 16. The recessed groove may comprise any suitable shape, such as v-shaped, semi-rectangular, semi-circular or semi-ovular, among others. The fully open detent 46 temporarily hinders the movement of the gas spring 18 to hold the drop safe door 12 in a fully opened position (as shown in FIG. 3). Although not shown, a distal end of the cam surface 16 or a distal portion of the initial force bracket 36 may contain a fully closed detent, such as a recessed groove, to temporarily hinder the movement of the gas spring 18 to hold the drop safe door 12 in a fully closed position.

In the depicted embodiment, the combination of the initial force bracket 36 and the cam surface 16 forms a curve that initially bends upward and then bends downward. In one embodiment, the apex of the curve is at the neutral point detent 42. However, in other embodiments, the apex of the curve may be in the initial force bracket 36 portion of the curve or in the cam surface 16 portion of the curve. In one embodiment, the shape of the curve can be determined based on a mathematical formula that takes into account the length of the link 32, the x-y coordinates of the center of gravity of the door 12, the weight of the door 12, the rotation angle of the door 12 with respect to the vertical/closed door position at every point along the curve, the force of the gas spring 18 at full strength, the minimum compression length of the gas spring 18, the maximum extension length of the gas spring 18, the x-y coordinates of the pivot bracket 30, the x-y coordinates of the door mounting bracket 34, the angle of the door fully opened position with respect to a vertical plane and the angle to the door fully closed position with respect to the vertical plane.

As one of ordinary skill in the art will understand, a gas spring continually applies a force towards extension of the gas spring. As a result, when a deadbolt (not shown), or another similar locking means that is secured against the drop safe door 12, is moved to an unlocked position, typically by activating a key cylinder or a combination tumbler, the gas spring 18 applies an extension force on the initial force bracket 36 causing the cam bearing 26 to move along the initial force bracket 36, which, in turn, causes the link 32 to apply a force to the door 12 to open the door 12, such as by rotating the door 12 about one or more hinges 48. Thus, upon unlocking the door 12, the gas spring 18 automatically applies a force on the door 12 to open the door 12.

However, in the door closed position, the center of gravity of the door 12 causes the weight of the door 12 to resist opening. Therefore, the gas spring 18 must be chosen such that it is strong enough to overcome the weight of the door 12. By choosing an appropriate strength of gas spring 18, the counteracting forces of the gas spring 18 and the weight of the door 12, produces a relatively slow movement of the door 12 as the door 12 moves from the closed position to the neutral point detent 42, such that the likelihood of operator injury is reduced.

As shown in FIG. 2, upon unlocking the door 12, the gas spring 18 extends and thus the cam bearing 26 moves along the initial force bracket 36 until the cam bearing 26 reaches the neutral point detent 42. At the neutral point detent 42, the cam bearing 26 is temporarily held in place, such that the drop safe door 12 is temporarily held in the partially opened position.

In depicted embodiment, when the cam bearing 26 is in the neutral point detent 42 such that the drop safe door 12 is held in the partially opened position, the door 12 is opened to an angle α, with respect to a vertical/closed door position, that is in a range of approximately 15° to approximately 35°. In one embodiment, the angle α of the partially opened position is approximately 25°.

Once the cam bearing 26 is in the neutral point detent 42, the cam bearing 26, and thus the door 12, is held in position until an operator applies an external force to the door 12 in either the door closing or the door opening direction. When the operator applies an appropriate external force to the door 12 in the door opening direction, i.e. a force that is sufficient to compress the gas spring 18, the gas spring 18 disengages from the neutral point detent 42, such that the cam bearing 26 may move to a position proximal to the neutral point detent 42. The operator may then continue to apply an external force to the door 12 in the door opening direction until the cam bearing 26 reaches the fully open detent 46. At the fully open detent 46 the cam bearing 26, and thus the door 12, is held in place. In one embodiment, when the cam bearing 26 is positioned at any point between the neutral point detent 42 and the fully open detent 46, the gas spring 18 produces a force on the door 12 to counteract the weight of the door 12 to prevent the door 12 from rapidly opening and possibly injuring the operator.

In the depicted embodiment of FIG. 3, when the cam bearing 26 is in the fully open detent 46, such that the drop safe door 12 is held in the fully opened position, the door 12 is opened to an angle β, with respect to a vertical/closed door position, that is in a range of approximately 85° to approximately 125°. For instance, in one example, the angle β of the fully opened position is approximately 105°.

In one embodiment, when the door 12 is at any position between the partially opened and the fully opened positions, i.e. anywhere between the angle α and the angle β, and the door 12 is free from external forces, the cam bearing 26 automatically moves along the cam surface 16, due to the extension force of the gas spring 18, until the cam bearing 26 engages the neutral point detent 42. This embodiment may be produced by choosing a gas spring 18 and a center of gravity of the door, wherein the strength of the gas spring 18 is great enough to overcome the weight of the door 12 at every point between the neutral point detent 42 and the fully open detent 46 of the cam surface 16.

Once the cam bearing 26 is in the fully open detent 46, the cam bearing 26, and thus the door 12, is held in position until the operator applies an appropriate external force to the door 12 in the door closing direction, i.e. a force that is sufficient to compress the gas spring 18 to disengage the gas spring 18 from the fully open detent 46, such that the cam bearing 26 may move to a position distal to the fully open detent 46. In one embodiment, once the cam bearing 26 is in a position distal to the fully open detent 46, and the door 12 is free from external forces, the cam bearing 26 automatically moves along the cam surface 16, due to the extension force of the gas spring 18, until the cam bearing 26 engages the neutral point detent 42.

As described above, once the cam bearing 26 is in the neutral point detent 42, the cam bearing 26, and thus the door 12, is held in position until an operator applies an external force to the door 12 in either the door closing or the door opening direction. When the operator applies an appropriate external force to the door 12 in the door closing direction, i.e. a force that is sufficient to compress the gas spring 18, the gas spring 18 disengages from the neutral point detent 42, such that the cam bearing 26 may move to a position distal to the neutral point detent 42. With the cam bearing 26 positioned distal to the neutral point detent 42, the operator may continue to apply an appropriate external force to the door 12 to move the cam bearing 26 along the initial force bracket 36 until the door 12 reaches the closed position and the door 12 is locked by actuation of a deadbolt or another similar locking means that secures the door 12 in the closed door position.

In one embodiment, when the cam bearing 26 is positioned at any position proximal to the closed door position and distal to the neutral point detent 42, the gas spring 18 automatically forces the cam bearing 26 towards the neutral point detent 42. Thus, an explicit force is required by the operator in order to close the door 12. Consequently, the risk of injury caused by the previously described “self-closing” door of the prior art is reduced.

In one embodiment, the initial force bracket 36 is rotatably mounted to the cam 14 (as discussed below), which allows the upward bend of the curve defined by the initial force bracket 36 to be increased (i.e. by a counter-clockwise movement) or decreased i.e. by a clockwise movement) as desired. Increasing or decreasing the upward bend of the curve defined by the initial force bracket 36, respectively, increases or decreases the force that the gas spring 18 exerts on the door 12 as the cam bearing 26 moves along the initial force bracket 36. This adjustment is desirable because over time the gas spring 18 loses pressure and therefore produces a less forceful extension force. This is due to the gas that is internally disposed within the gas spring 18. The internally disposed gas supplies pressure to the gas spring 18 to allow the gas spring 18 to continually exert an extension force. Since the seals that contain the internally disposed gas are not perfect seals, over time some of the gas seeps through the seals and the gas spring 18 consequently loses some of its internal pressure. When this occurs, the initial force bracket 36 can be rotated upward, such that the upward bend of the curve defined by the initial force bracket 36 is increased. This increases the force that is transferred from the gas spring 18 to the door 12. Thus, rotatably mounting the initial force bracket 36 to the cam 14 increases the useful life of the gas spring 18.

In one embodiment, the door 12 is approximately 45 pounds (lbs.) and the gas spring 18 is a 120 pound gas spring. In this embodiment, the counterforces of the gas spring 18 and the weight of the door 12 produces an approximately constant force on the door 12 in the range of 5 to 10 lbs. This force can easily be overcome by the operator and makes an otherwise heavy door easy to manipulate. It should be noted that in some embodiments there are points in the movement of the cam bearing 26 along either the initial force bracket 36 or the cam surface 16 were the force of the gas spring 18 and the weight of the door are not counteracting, i.e., they each exert a force on the door 12 in either the door closing direction or the door opening direction.

FIGS. 6 and 7 show one method of rotatably mounting the initial force bracket 36 to the cam 14. A mounting bracket 50 is attached to the cam 14 by at least one screw fastener 52, or another appropriate fastening means. The initial force bracket 36, in turn, is similarly attached to the mounting bracket 50 by at least one screw fastener 53, or another appropriate fastening means. The mounting bracket 50 comprises openings for receiving the screw fasteners 52, wherein at least one of the openings is a slotted opening 54. The at least one slotted opening 54 allows the mounting bracket 50 to be rotated upwardly or downwardly, to correspondingly adjust the initial force bracket 36 upwardly or downwardly. Although not shown, in another embodiment the initial force bracket 36 is mounted directly to the cam 14.

As previously discussed and as shown in FIG. 4, in one embodiment, the proximal end 38 of the initial force bracket 36 and the distal end 40 of the cam surface 16 combine to form a neutral point detent 42. In one embodiment, the corresponding facing surfaces 38F and 40F, respectively, of the initial force bracket 36 and the cam surface 16 (as shown in FIG. 4) are concentric about the same center point 55 (as shown in FIGS. 1-3 and 6-7). As such, when the initial force bracket 36 is rotated, a spacing between the facing surfaces 38F and 40F of the initial force bracket 36 and the cam surface 16, respectively, remains unchanged.

In one embodiment, a distal portion of the cam surface 16 has a recessed area 56. For example, as shown in FIG. 6, a distal portion of the slot 22 in the cam 14 comprises the recessed area 56. In such an embodiment, the initial force bracket 36 may be attached to the cam 14, such that a portion of the initial force bracket overlaps at least a portion of the recessed area 56. The addition of the recessed area 56 facilitates the removal and/or replacement of the gas spring 18. For example, the cam bearing 26 may be positioned such that the cam bearing 26 does not contact the initial force bracket 36, such as by positioning the cam bearing 26 in the fully open detent 46. The initial force bracket 36 can then be removed from the cam 14. With the initial force bracket 36 removed from the cam 14, the cam bearing 26 may be moved to a position within the recessed area 56. At least a portion of the recessed area 56 should be recessed to an extent that when the cam bearing 26 is disposed therein, the gas spring 18 is allowed to fully extend. With the gas spring 18 in the fully extended position, the gas spring 18 can be easily removed from the drop safe 10 without the need for specialized tools, for example, by simply disengaging the proximal end 22 of the gas spring 18 from the yoke bracket 28 and disengaging the distal end 24 of the gas spring 18 from the pivot bracket 30.

Although the preceding description has described the cam surface 16 as having a initial force bracket 36 attached thereto, in one embodiment the cam surface 16 does not contain an initial force bracket 36. In such an embodiment, each of the detents (the fully closed detent, the neutral point detent 42 and the fully open detent 46) may be formed as recesses in or protrusions from the cam surface 16.

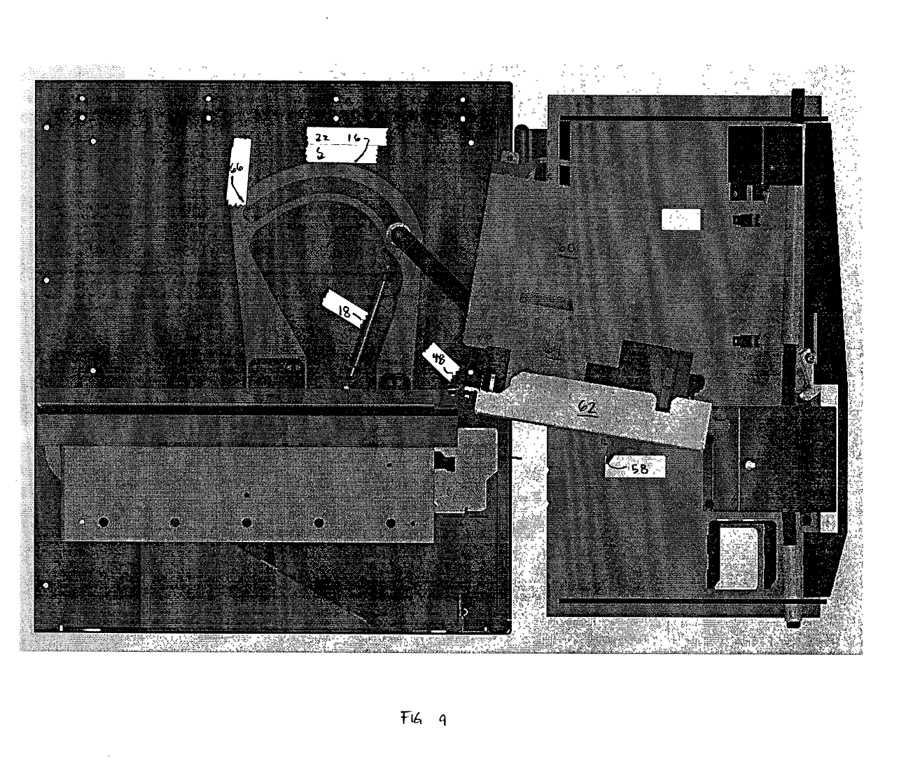

In addition, although the preceding description has described the gas spring 18 as being connected to a drop safe door 12, the gas spring 18 may alternatively be connected to any other pivoting component. For example, FIGS. 8-10 show an embodiment where the gas spring 18 is connected to a chassis 62 having at least one bill validator 58 and at least one corresponding bill validator cassette 60 mounted thereon. However, although the chassis 62 is shown as having at least one bill validator 58 and at least one corresponding bill validator cassette 60 mounted thereon, the chassis 62 may alternatively have mounted thereon another type of drop safe component, such as a loose coin dispenser, a rolled coined dispenser, an envelope drop system or a door locking system, or any combination thereof.

In the embodiment of FIGS. 8-10, the chassis 62 comprises two bill validator cassettes 60. Although the chassis 62 may comprise any number of bill validator cassettes 60, for clarity the following description will refer to the chassis 62 as having two bill validator cassettes 60.

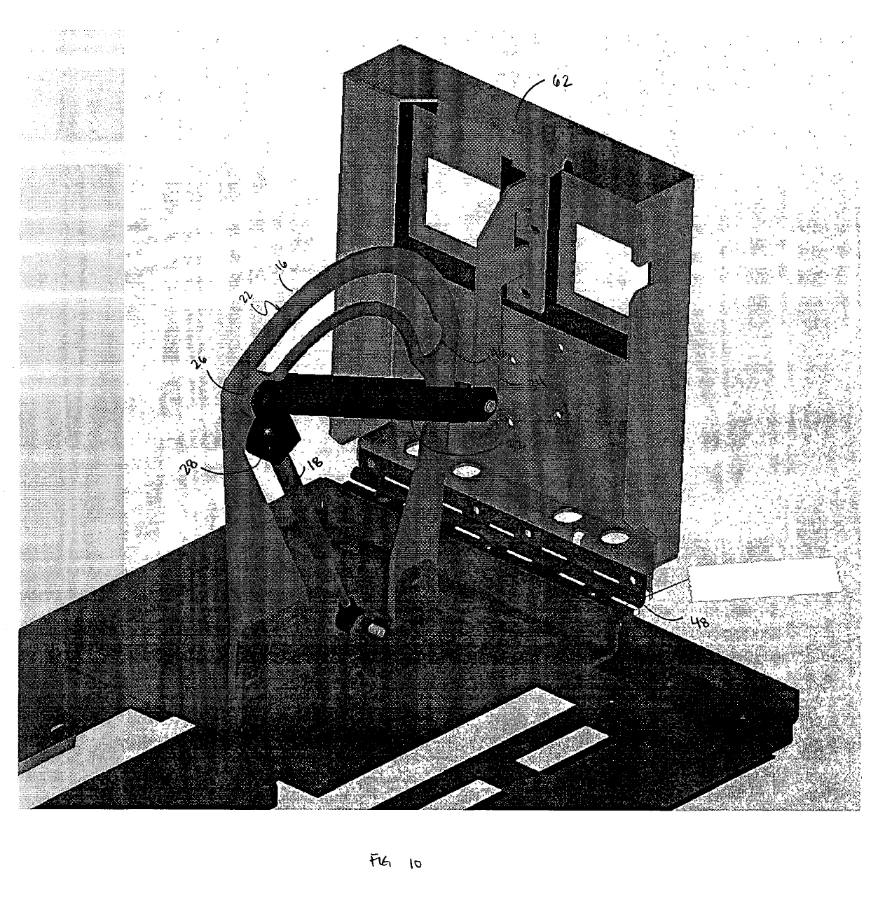

As shown in FIGS. 8-10, each bill validator cassettes 60 is attached to a corresponding bill validator 58. The bill validator 58 receives and validates paper currency. The bill validators 58 send validated paper currency to the bill validator cassette 60 for storage. Each bill validator cassette 60 is mounted to the chassis 62, either directly (not shown) or through a mounting bracket 64 (as shown in FIGS. 8 and 9). As with the drop safe door 12, the chassis 62 is relatively heavy and, without the aid of the gas spring 18, has a tendency to slam shut when moved in a closing direction and a tendency to rapidly swing open when moved in an opening direction.

Consequently, the gas spring 18 is attached to the chassis 62 or mounting bracket, as described above with respect to the drop safe door 12, to facilitate rotating the chassis 62 between an closed position (as shown in FIG. 8) and an opened position (as shown in FIG. 9). In one embodiment, the cam surface 16 comprises a fully closed detent 66 for holding the chassis 62 in the closed position and a fully open detent 46 for holding the chassis 62 in the fully open position as described above. In addition, the cam surface 16 may comprise the neutral point detent 42 as described above for holding the chassis 62 in the partially open position.

In another embodiment, the cam surface 16 comprises a counter balanced region. The counter balanced region is a region along the cam surface 16 wherein the sum of the forces on the cam bearing 26 approaches zero due to the counteracting forces of the weight of the chassis 62 and the force of the gas spring 18 on the cam bearing 26. Thus, when the cam bearing 26 is in the counter balanced region, the chassis 62 is held in the partially open position. Alternatively, the cam surface 16 may comprise neither the neutral point detent 42 nor the counter balanced region.

In the depicted embodiment, the gas spring 18 is disposed between the bill validator cassettes 60. However, in other embodiments, the gas spring 18 may be disposed in other positions, such as adjacent to the bill validator cassette 60. Alternatively, more than one gas spring 18 may be mounted to the chassis 62. For example, the chassis 62 may comprise one gas spring 18 adjacently disposed to each corresponding bill validator cassette 60.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, spirit and scope of this invention. Accordingly, the foregoing description should not be read as pertaining only to the precise structures described and shown in the accompanying drawings, but rather should be read as consistent with and as support for the following claims, which are to have their fullest and fairest scope.

1. A drop safe comprising:
a cam attached to an interior surface of the drop safe, the cam having a cam surface;
a gas spring having a cam bearing at one end of the gas spring, wherein the cam bearing moves along the cam surface;
a pivoting component; and
a link attached to the gas spring and to the pivoting component, wherein as the cam bearing moves along the cam surface, the link applies a force to the pivoting component.

2. The drop safe of claim 1, wherein the cam surface has a neutral point detent for holding the pivoting component in a partially opened position and a fully open detent for holding the pivoting component in a fully opened position.

3. The drop safe of claim 2, further comprising an initial force bracket attached to the cam, wherein the cam bearing moves along the initial force bracket and along the cam surface, and wherein a proximal end of the initial force bracket and a distal portion of the cam surface combine to form the neutral point detent.

4. The drop safe of claim 3, wherein the neutral point detent is a substantially v-shaped gap between the proximal end of the initial force bracket and the distal portion of the cam surface.

5. The drop safe of claim 3, wherein the initial force bracket is rotatably mounted to the cam, such that an initial force, that is transferred from the gas spring to the pivoting component as the cam bearing moves along the initial force bracket, is adjustable.

6. The drop safe of claim 3, wherein the initial force bracket is removably attached to the cam, such that when the initial force bracket is detached from the cam, the gas spring is allowed to extend to a fully extended position, such that removal of the gas spring is facilitated.

7. The drop safe of claim 2, wherein the cam surface fully open detent is formed as a curved recess at a proximal end of the cam surface.

8. The drop safe of claim 1, wherein the cam surface has a fully closed detent for holding the pivoting component in a fully closed position and a fully open detent for holding the pivoting component in a fully opened position.

9. The drop safe of claim 1, wherein the pivoting component is a drop safe door.

10. The drop safe of claim 1, wherein the pivoting component is a chassis having at least one drop safe component mounted thereon, wherein the at least one drop safe component is selected from the group consisting of a bill validator cassette, a loose coin dispenser, a rolled coined dispenser, an envelope drop system and a door locking system.

11. A drop safe comprising:
a cam attached to an interior surface of the drop safe, the cam having a slot defining a cam surface;
a gas spring having a cam bearing at one end of the gas spring, wherein the cam bearing moves within the slot along the cam surface;
a pivoting component; and
a link attached to the gas spring and to the pivoting component, wherein as the cam bearing moves within the slot along the cam surface, the link applies a force to the pivoting component.

12. The drop safe of claim 11, wherein the cam surface has a neutral point detent for holding the pivoting component in a partially opened position and a fully open detent for holding the pivoting component in a fully opened position.

13. The drop safe of claim 12, further comprising an initial force bracket attached to the cam, such that a portion of the initial force bracket overlaps a recessed area in a distal end of the slot, and wherein the cam bearing moves within the slot along the initial force bracket and along the cam surface, and wherein a proximal end of the initial force bracket and a distal portion of the cam surface combine to form the neutral point detent.

14. The drop safe of claim 13, wherein the neutral point detent is a substantially v-shaped gap between the proximal end of the initial force bracket and the distal portion of the cam surface.

15. The drop safe of claim 13, wherein the initial force bracket is rotatably mounted to the cam, such that an initial force, that is transferred from the gas spring to the pivoting component as the cam bearing moves within the slot along the initial force bracket, is adjustable.

16. The drop safe of claim 13, wherein the initial force bracket is removably attached to the cam, such that when the initial force bracket is detached from the cam, the portion of the slot that was overlapped by the initial force bracket is exposed, allowing the gas spring to extend to a fully extended position, such that removal of the gas spring is facilitated.

17. The drop safe of claim 2, wherein the cam surface fully open detent is formed as a curved recess in the cam surface at a proximal end of the slot.

18. The drop safe of claim 11, wherein the cam surface has a fully closed detent for holding the pivoting component in a fully closed position and a fully open detent for holding the pivoting component in a fully opened position.

19. The drop safe of claim 11, wherein the pivoting component is a drop safe door.

20. The drop safe of claim 11, wherein the pivoting component is a chassis having at least one drop safe component mounted thereon, wherein the at least one drop safe component is selected from the group consisting of a bill validator cassette, a loose coin dispenser, a rolled coined dispenser, an envelope drop system and a door locking system.
